(19) United States
(12) Patent Application Publication
(10) Pub. No.: US 2019/0337164 A1
(43) Pub. Date: Nov. 7, 2019

(54) TRANSFERRING SYSTEM AND METHOD OF OPERATING THE SAME

(71) Applicant: KAWASAKI JUKOGYO KABUSHIKI KAISHA, Kobe-shi, Hyogo (JP)

(72) Inventor: Kazunori HIRATA, Yao-shi (JP)

(73) Assignee: KAWASAKI JUKOGYO KABUSHIKI KAISHA, Kobe-shi, Hyogo (JP)

(21) Appl. No.: 16/468,961

(22) PCT Filed: Dec. 21, 2017
(86) PCT No.: PCT/JP2017/045964

§ 371 Date: Jun. 12, 2019

(30) Foreign Application Priority Data
Dec. 22, 2016 (JP) 2016-249847

(51) Int. Cl. B25J 15/06; B25J 9/00; B65B 43/18; B65B 43/46; B65B 5/04; B65B 35/16

(52) U.S. Cl. CPC B25J 15/0616; B25J 9/0087; B65B 35/16; B65B 43/465; B65B 5/045; B65B 43/18

(57) ABSTRACT

A transferring system includes a robot including a first arm having a pair of first holding parts and a second arm having a pair of second holding parts, a packing bag feeding device, and a control device. A suction part is provided to the inner surface of the first holding part. The control device operates the packing bag feeding device to feed a packing bag while opening its opening, then operates the first arm so that the inner surfaces of the pair of first holding parts contact the outer surface of the packing bag, the suction part sucks the outer surface, and a distance between the inner surfaces of the pair of first holding parts becomes larger than a length of food.

### TECHNICAL FIELD

The present disclosure relates to a transferring system and a method of operating the same.

### BACKGROUND ART

An article gripping device and a container packing device which grip an article and accommodate it into a container are known (for example, refer to Patent Document 1). The article gripping device disclosed in Patent Document 1 includes a main body, and a pair of grippers provided to the main body. The pair of grippers are moved forward by a driving unit to grip an article, and the pair of grippers are moved rearward to release the gripped article.

Moreover, the container packing device disclosed in Patent Document 1 has an upper plate and a lower plate to which suction cups are provided.

The suction cup of the upper plate sucks an upper surface of a film bag, and the suction cup of the lower plate sucks a lower surface of the film bag while the film bag is sandwiched by the upper plate and the lower plate. Then, the upper plate and the lower plate are moved so as to be separated from each other to open the film bag, and the article (sandwiches) gripped by the article gripping device are accommodated into the film bag.

### REFERENCE DOCUMENT OF CONVENTIONAL ART

### Patent Document

[Patent Document 1] JP2014-198571A

### DESCRIPTION OF THE DISCLOSURE

### Problems to be Solved by the Disclosure

However, in the container packing device disclosed in Patent Document 1, although the upper surface and the lower surface of the film bag are held by the suction, the side surfaces are not held. Moreover, in the article gripping device disclosed in Patent Document 1, the pair of grippers move forward and rearward inside the film bag, while being located at the side surfaces of the film bag. Therefore, if the positions of the pair of grippers and the position of the film bag are deviated, the gripper moves inside the film bag while pushing the side surfaces of the film bag outside, which may damage the film bag. Moreover, when the side surfaces of the film bag are bent inwardly, the pinching body contacts the film bag, which may damage the film bag.

The present disclosure is made in view of solving the conventional problems, and one purpose thereof is to provide a transferring system and a method of operating the same, capable of transferring a gripped food into the packing bag, while preventing breakage of the packing bag.

### Summary of the Disclosure

In order to solve the conventional problem, a transferring system according to one aspect of the present disclosure is a system configured to hold and transfer food. The system includes a robot including a first arm having a pair of first holding parts, each formed in a plate shape, and the first holding parts being disposed so that inner surfaces thereof oppose to each other, and a second arm having a pair of second holding parts, each formed in a plate shape, and the second holding parts being disposed so that inner surfaces thereof oppose to each other, and configured to be changeable of a distance between the inner surfaces. The system includes a packing bag feeding device configured to feed each of stacked packing bags one by one, while opening an opening of the packing bag, and a control device. A suction part is provided to the inner surface of the second holding part. The control device operates the packing bag feeding device to feed the packing bag while opening the opening of the packing bag, then operates the first arm so that the inner surfaces of the pair of first holding parts contact the outer surface of the packing bag, the suction part sucks the outer surface of the packing bag, and a distance between the inner surfaces of the pair of first holding parts becomes larger than a length of the food.

According to this configuration, the gripped food can be transferred into the packing bag, while preventing breakage of the packing bag.

Moreover, a method of operating a transferring system according to another aspect of the present disclosure is a method of operating a transferring system configured to hold and transfer food. The transferring system includes a robot including a first arm having a pair of first holding parts, each formed in a plate shape, and the first holding parts being disposed so that inner surfaces thereof oppose to each other, and a second arm having a pair of second holding parts, each formed in a plate shape, and the second holding parts being disposed so that inner surfaces thereof oppose to each other, and configured to be changeable of a distance between the inner surfaces. The system includes a packing bag feeding device configured to feed each of stacked packing bags one by one, while opening an opening of the packing bag. A suction part is provided to the inner surface of the second holding part. The method comprising the steps of (A) operating the packing bag feeding device to feed the packing bag while opening the opening of the packing bag, and (B) operating the first arm so that the inner surfaces of the pair of first holding parts contact the outer surface of the packing bag, the suction part sucks the outer surface of the packing bag, and a distance between the inner surfaces of the pair of first holding parts becomes larger than a length of the food, after (A).

Thus, the gripped food can be transferred into the packing bag, while preventing breakage of the packing bag.

### Effect of the Disclosure

According to the transferring system and the method of operating the same of the present disclosure, the gripped food can be transferred into the packing bag, while preventing breakage of the packing bag.

### BRIEF DESCRIPTION OF DRAWINGS

FIG. 1 is a schematic view illustrating an outline structure of a transferring system according to Embodiment 1.

FIG. 2 is a schematic view illustrating an outline structure of a robot in the transferring system illustrated in FIG. 1.

FIG. 3 is a functional block diagram schematically illustrating a configuration of a control device of the robot illustrated in FIG. 2.

FIG. 4 is a schematic view illustrating an outline structure of a right side surface of a first hand part in the robot illustrated in FIG. 2.

FIG. 5 is a schematic view illustrating an outline structure of a front surface of the first hand part in the robot illustrated in FIG. 2.

FIG. 6 is a schematic view illustrating an outline structure of a left side surface of a second hand part in the robot illustrated in FIG. 2.

FIG. 7A is a flowchart illustrating one example of operation of the transferring system according to Embodiment 1.

FIG. 7B is a flowchart illustrating the example of operation of the transferring system according to Embodiment 1.

FIG. 8 is a schematic view illustrating a state of the robot when the robot operates according to the flowchart illustrated in FIGS. 7A and 7B.

FIG. 9 is a schematic view illustrating a state of the robot when the robot operates according to the flowchart illustrated in FIGS. 7A and 7B.

FIG. 10 is a schematic view illustrating a state of the robot when the robot operates according to the flowchart illustrated in FIGS. 7A and 7B.

FIG. 11A is a flowchart illustrating one example of operation of a transferring system according to Embodiment 2.

FIG. 11B is a flowchart illustrating the example of operation of the transferring system according to Embodiment 2.

FIG. 12 is a schematic view illustrating an outline structure of a transferring system according to Embodiment 3.

### MODES FOR CARRYING OUT THE DISCLOSURE

Hereinafter, embodiments of the present disclosure will be described with reference to the drawings. Note that, throughout the drawings, the same reference characters are given to the same or corresponding parts to omit redundant description. Moreover, throughout the drawings, components for describing the present disclosure are selectively illustrated, and illustration of other components may be omitted. Further, the present disclosure is not limited to the following embodiments.

### Embodiment 1

A transferring system according to Embodiment 1 is a transferring system which holds and transfers food. This system is provided with a robot which includes a first arm having a pair of first holding parts, each formed in a plate shape. The first holding parts are disposed so that inner surfaces thereof oppose to each other, and are configured to be changeable of a distance between the inner surfaces. The robot also includes a second arm having a pair of second holding parts, each formed in a plate shape. The second holding parts are disposed so that inner surfaces thereof oppose to each other. The system is also provided with a packing bag feeding device configured to feed one of stacked packing bags one by one, while opening the opening of the packing bag. The system also includes a control device. The inner surfaces of the first holding parts are each provided with a suction part. The control device operates the packing bag feeding device so as to feed the packing bag while opening the opening of the packing bag. Then, the control device operates the first arm so that the inner surfaces of the pair of first holding parts contact an outer surface of the packing bag, and the suction part sucks the outer surface of the packing bag, and a distance between the inner surfaces of the pair of first holding parts becomes larger than a length of the food.

Moreover, in the transferring system according to Embodiment 1, the control device may be configured to operate the second arm so that the pair of second holding parts hold the food, and the held food is inserted into the packing bag through the opening of the packing bag.

Moreover, in the transferring system according to Embodiment 1, the control device may be configured to operate the second arm so that a normal direction of the inner surfaces of the pair of second holding parts is in agreement with a normal direction of the inner surfaces of the pair of first holding parts.

Further, in the transferring system according to Embodiment 1, the control device may be configured to operate the second arm so that the hold of the food by the pair of second holding parts is released, and the pair of second holding parts are retreated from the inside of the packing bag, and then operate the first arm so that the pair of first holding parts hold the food from the outer surface of the packing bag.

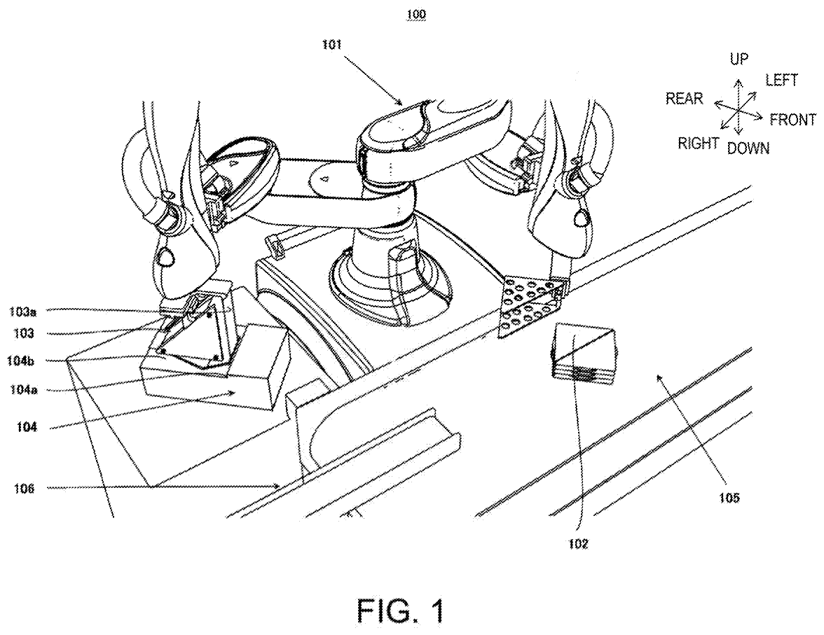

Hereinafter, one example of the transferring system according to Embodiment 1 is described with reference to FIGS. 1 to 10.

### [Configuration of Transferring System]

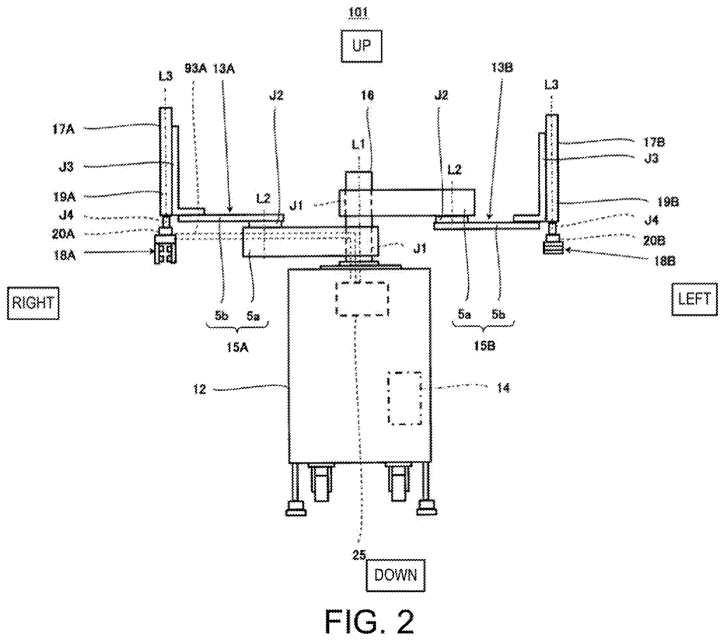

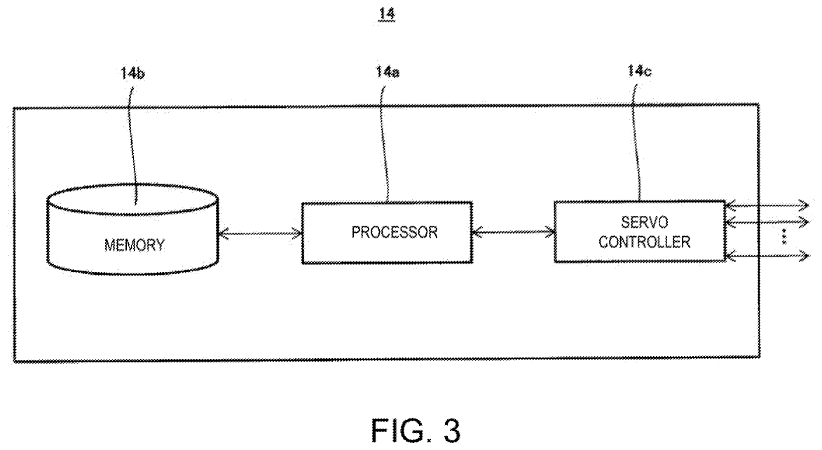

FIG. 1 is a schematic view illustrating an outline structure of the transferring system according to Embodiment 1. FIG. 2 is a schematic view illustrating an outline structure of a robot in the transferring system illustrated in FIG. 1. FIG. 3 is a functional block diagram schematically illustrating a configuration of a robot control device illustrated in FIG. 2.

Note that, in FIG. 1, a front-and-rear direction, an up-and-down direction, and a left-and-right direction of the robot are expressed as a front-and-rear direction, an up-and-down direction, and a left-and-right direction in this figure, respectively. Moreover, in FIG. 2, the up-and-down direction and the left-and-right direction of the robot are expressed as an up-and-down direction and a left-and-right direction in this figure, respectively.

As illustrated in FIG. 1, a transferring system 100 according to Embodiment 1 includes a robot 101, a food (here, sandwiches) 102, a packing bag feeding device 104 configured to feed one packing bag 103 at a time, a first belt conveyor 105, and a second belt conveyor 106. The system 100 is configured so that the food 102 transferred (fed) from the first belt conveyor 105 is accommodated into the packing bag 103, and the bagged food 102 is transferred onto the second belt conveyor 106. Note that the food 102 transferred by the transferring system 100 according to Embodiment 1 may be, for example, sandwiches, Japanese confectionery, Western confectionery, or rice balls.

The packing bag feeding device 104 is formed in a substantially box shape, and is provided therein with a feeder (not illustrated) which feeds one packing bag 103 at a time, where a plurality of packing bags 103 are accommodated in a stacked manner

An upper surface of the packing bag feeding device 104 is formed in a stepped shape by a stepped part 104a, and one packing bag 103 is fed at a time by the feeder (not illustrated) to an upper surface 104b rearward of the stepped part 104a. Moreover, in a side wall which constitutes the stepped part 104a, a nozzle part (not illustrated) is provided, through which gas, such as air, is blown off to open the opening of the packing bag 103. The nozzle part is connected to a gas feeder (not illustrated) for blowing off the gas, such as air.

Thus, the packing bag feeding device 104 can feed one of stacked packing bags 103 at a time, while opening the opening of the packing bag 103a. Note that, as the packing bag feeding device 104 configured in this way, BLOWPACKER (product name) etc. may be used, for example.

The first belt conveyor 105 is configured to convey the food 102 (for example, cooked food) to a location in front of the robot 101. Moreover, the second belt conveyor 106 is configured to convey the food 102 bagged by the robot 101, and a sealing mechanism (not illustrated) which seals the opening 103a of the packing bag 103 is disposed at a destination of the second belt conveyor 106.

Next, a concrete configuration of the robot 101 is described with reference to FIG. 2. Note that, in the following, although a horizontal articulated dual-arm robot is described as the robot 101, other robots of horizontal articulated or vertical articulated type may also be adopted as the robot 101.

As illustrated in FIG. 2, the robot 101 includes a carrier 12, a first arm 13A, a second arm 13B, a vacuum generator 25, and a control device 14. The control device 14 is configured to control the first arm 13A, the second arm 13B, and the vacuum generator 25. Note that, in Embodiment 1, although the form in which the control device 14 and the vacuum generator 25 are disposed inside the carrier 12 is adopted, it is not limited to this structure and these apparatuses may be disposed outside the carrier 12.

A base shaft 16 is fixed to an upper surface of the carrier 12. The base shaft 16 is provided with the first arm 13A and the second arm 13B so as to be rotatable on a rotation axis L1 passing through the axial center of the base shaft 16. Specifically, the first arm 13A and the second arm 13B are provided so as to have a height difference therebetween. Further, in the carrier 12, the control device 14 and the vacuum generator 25 are accommodated. Note that the first arm 13A and the second arm 13B are configured so as to operate independently or dependently.

The first arm 13A includes a first arm part 15A, a first wrist part 17A, a first hand part 18A, and a first attaching part 20A. Similarly, the second arm 13B includes a second arm part 15B, a second wrist part 17B, a second hand part 18B, and a second attaching part 20B. Note that, since the second arm 13B is configured similarly to the first arm 13A other than second hand part 18B, the detailed description of the parts other than second hand part 18B is omitted.

In Embodiment 1, the first arm part 15A is comprised of a first link 5a and a second link 5b, each of which is of a substantially rectangular parallelepiped shape. The first link 5a is provided at a base-end part with a rotary joint J1, and provided at a tip-end part with a rotary joint J2. Moreover, the second link 5b is provided at a tip-end part with a linear-motion joint J3.

The first link 5a is coupled at the base-end part to the base shaft 16 through the rotary joint J1, and can be rotated about the rotation axis L1 by the rotary joint J1. Moreover, the second link 5b is coupled at a base-end part with the tip-end part of the first link 5a through the rotary joint J2, and can be rotated about a rotation axis L2 by the rotary joint J2.

The first wrist part 17A is coupled to the tip-end part of the second link 5b through the linear-motion joint J3 so as to be ascendable and descendable with respect to the second link 5b. A rotary joint J4 is provided to a lower end part of the first wrist part 17A, and the first attaching part 20A is provided to a lower end part of the rotary joint J4.

The first attaching part 20A is configured so that the first hand part 18A is attachable and detachable thereto/therefrom. Specifically, for example, the first attaching part 20A has a pair of bar members which is configured to be adjustable of an interval therebetween, and the first hand part 18A can be attached to the first wrist part 17A by pinching the first hand part 18A by the pair of bar members. Thus, the first hand part 18A can be rotated about a rotation axis L3 by the rotary joint J4. Note that tip-end parts of the bar members may be bent or curved.

Moreover, the joints J1-J4 of the first arm 13A and the second arm 13B are provided with drive motors (not illustrated) as one example of actuators, each of which relatively rotates or elevates two members coupled by the corresponding joint. The drive motor may be, for example, a servo motor which is servo-controlled by the control device 14. Moreover, each of the joints J1-J4 is provided with a rotation sensor (not illustrated) which detects a rotational position of the drive motor, a current sensor (not illustrated) which detects current for controlling the rotation of the drive motor. The rotation sensor may be, for example, an encoder.

Here, with reference to FIGS. 2, and 4 to 6, the first hand part 18A of the first arm 13A and the second hand part 18B of the second arm 13B are described in detail.

First, the first hand part 18A of the first arm 13A is described in detail with reference to FIGS. 2, 4, and 5.

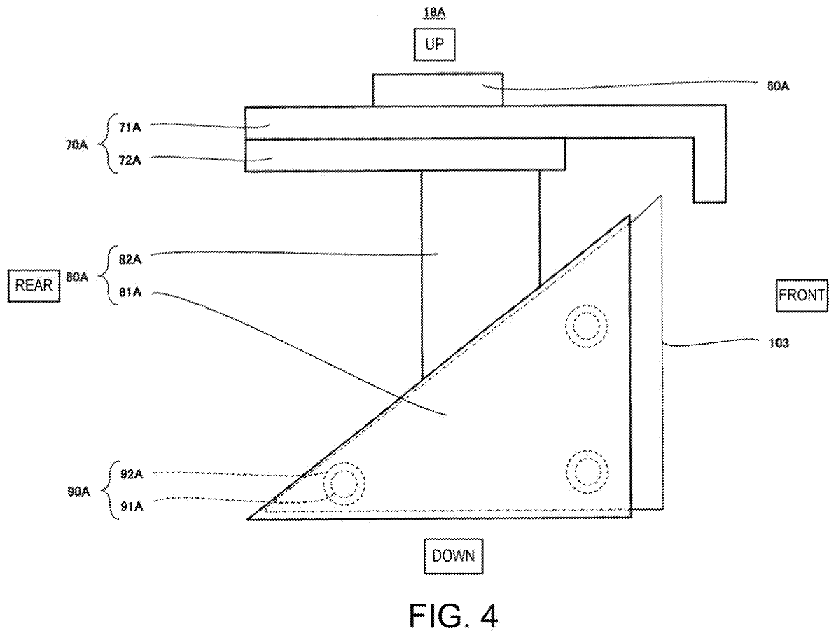

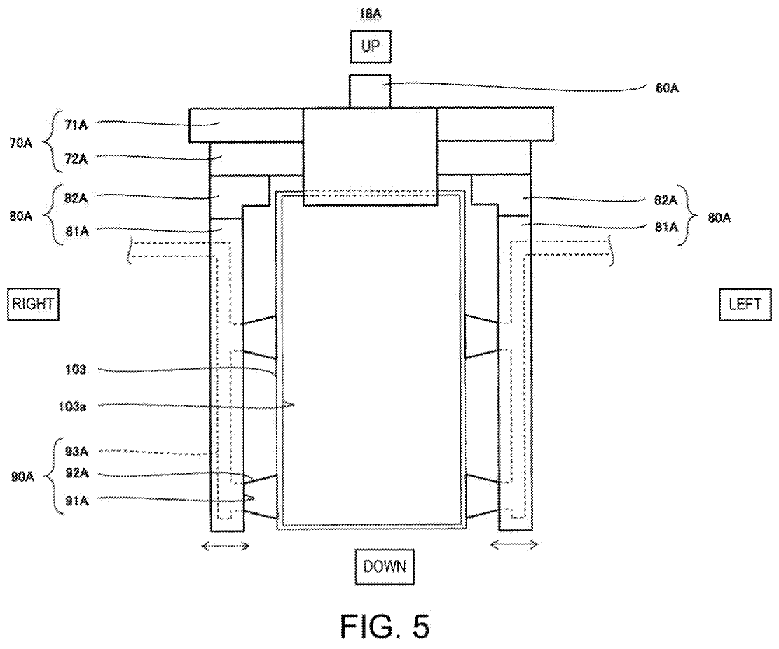

FIG. 4 is a schematic view illustrating an outline structure of a right side surface of the first hand part in the robot illustrated in FIG. 2. FIG. 5 is a schematic view illustrating an outline structure of a front surface of the first hand part in the robot illustrated in FIG. 2.

Note that, in FIG. 4, the up-and-down direction and the front-and-rear direction of the robot are expressed as an up-and-down direction and a front-and-rear direction in this figure, respectively, and in FIG. 5, the up-and-down direction and the left-and-right direction of the robot are expressed as an up-and-down direction and a left-and-right direction in this figure, respectively.

As illustrated in FIGS. 2, 4, and 5, the first hand part 18A of the first arm 13A is comprised of a stationary part 60A, a main body 70A, a pair of first holding parts 80A, and a first suction part 90A. The stationary part 60A is a part where the first attaching part 20A contacts, and is formed in a bar shape, here.

The main body 70A connects the stationary part 60A with the pair of first holding parts 80A, and includes a first member 71A and a plate-shaped second member 72A fixed to a lower surface of the first member 71A. The first member 71A is formed in a substantially T-shape when seen vertically, and is formed in a substantially L-shape when seen horizontally.

The pair of first holding parts 80A are disposed so that the inner surfaces of a first plate members 81A described later oppose to each other. Moreover, at least one of the first holding parts 80A is configured to be movable in a normal direction of a principal surface of the first plate member 81A by an actuator (not illustrated).

Thus, the pair of first holding parts 80A can change a distance between the inner surfaces of the first plate members 81A. Note that a groove etc. which guides the movement of the first holding part 80A may be formed in the lower surface of the second member 72A.

The first holding part 80A has the first plate member 81A of which a principal surface is formed in a triangular shape, and a substantially L-shaped second member 82A. The second member 82A connects the second member 72A with the first plate member 81A. Specifically, the second member 82A is connected at an upper end part to the second member 72A, and is connected at a lower end part to a sloped surface of the first plate member 81A. In other words, the second member 82A suspends the first plate member 81A from the lower surface of the second member 72A.

Moreover, one or more (here, three) openings 91A are formed in the inner surface of the first plate member 81A, and a truncated-cone-shaped suction pad 92A is provided to the opening 91A. Moreover, the openings 91A are connected with a vacuum generator 25 through a first piping 93A (refer to FIG. 2). Note that the openings 91A, the suction pads 92A, and the first piping 93A constitute the first suction part 90A.

The vacuum generator 25 is a device which vacuums the inside of the first suction part 90A to a negative pressure, and may be, for example, a vacuum pump or CONVUM®. An on-off valve (not illustrated) is provided to the first piping 93A. As the on-off valve opens or closes the first piping 93A, suction and release of the packing bag 103 by the suction pads 92A are performed. Note that the operation of the vacuum generator 25 and the opening and closing of the on-off valve are controlled by the control device 14.

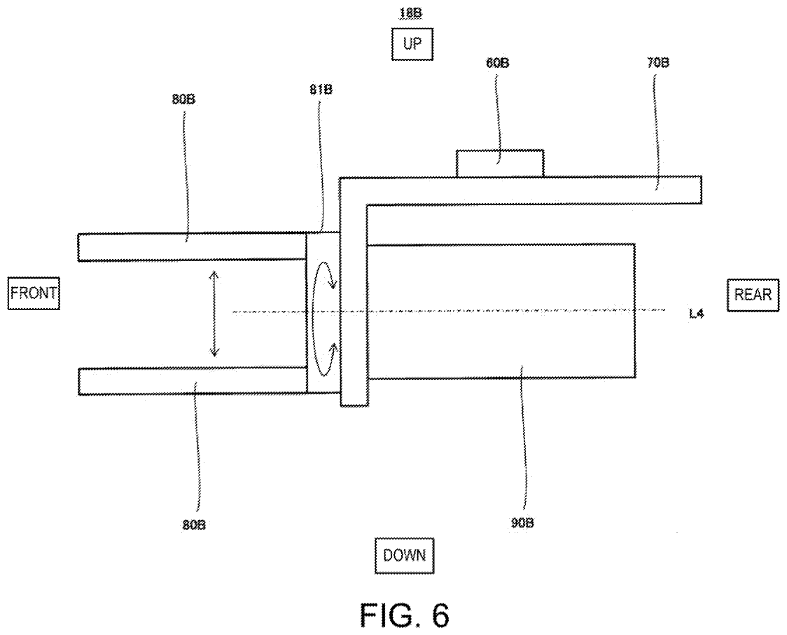

Next, the second hand part 18B of the second arm 13B is described in detail with reference to FIGS. 2 and 6.

FIG. 6 is a schematic view illustrating an outline structure of a left side surface of the second hand part in the robot illustrated in FIG. 2. Note that, in FIG. 6, the up-and-down direction and the front-and-rear direction of the robot are expressed as an up-and-down direction and a front-and-rear direction in this figure, respectively.

As illustrated in FIGS. 2 and 6, the second hand part 18B is comprised of a stationary part 60B, a main body 70B, a pair of second holding parts 80B, and an actuator 90B. The stationary part 60B is a part where the second attaching part 20B contacts, and is formed in a bar shape, here.

The main body 70B is formed in a substantially L-shape. The stationary part 60B is connected to an upper surface of the main body 70B, and the actuator 90B is provided to a side surface rearward of the main body 70B. Moreover, a pedestal 81B is provided to a side surface forward of the main body 70B.

Rear end parts of the plate-shaped second holding parts 80B are connected to the pedestal 81B. In more detail, the pair of second holding parts 80B are disposed in the pedestal 81B so that their principal surfaces (inner surfaces) oppose to each other. The principal surface of the second holding part 80B is formed in a triangular shape. Moreover, a plurality of through-holes are formed in the principal surface of the second holding part 80B.

Moreover, the pair of second holding parts 80B are configured so as to be rotatable by the actuator 90B on the rotation axis L4 through the pedestal 81B. Moreover, at least one of the second holding parts 80B is configured to be movable by the actuator 90B in the normal direction of the principal surface.

The actuator 90B may be, for example, a servo motor which is servo-controlled by the control device 14. Moreover, a rotation sensor (not illustrated) which detects a rotational position of the motor, a current sensor (not illustrated) which detects current for controlling the rotation of the motor are provided at a suitable location of the main body 70B. The rotation sensor may be, for example, an encoder.

As illustrated in FIG. 3, the control device 14 includes a processor 14a, such as a CPU, a memory 14b, such as a ROM and/or a RAM, and a servo controller 14c. The control device 14 is, for example, a robot controller provided with a computer, such as a microcontroller.

Note that the control device 14 may be comprised of a sole control device 14 which carries out a centralized control, and may be comprised of a plurality of control devices 14 which collaboratively carries out a distributed control. Moreover, in Embodiment 1, although the form in which the memory 14b is disposed inside the control device 14 is adopted, it is not limited to this structure and a form in which the memory 14b is provided separately from the control device 14 may be adopted.

The memory 14b stores information on a basic program as the robot controller, various fixed data, etc. The processor 14a controls various operations of the robot 101 by reading and executing software, such as the basic program stored in the memory 14b. That is, the processor 14a generates a control instruction of the robot 101, and outputs it to the servo controller 14c. The servo controller 14c is configured to control the drive of the servo motors corresponding to the joints J1-J4 of the first arm 13A and the second arm 13B of the robot 101, and the actuator 90B based on the control instructions generated by the processor 14a.

### [Operation of Transferring System]

Next, operation of the transferring system 100 according to Embodiment 1 is described with reference to FIGS. 1 to 10. Note that the following operation is executed by the processor 14a of the control device 14 reading the program stored in the memory 14b.

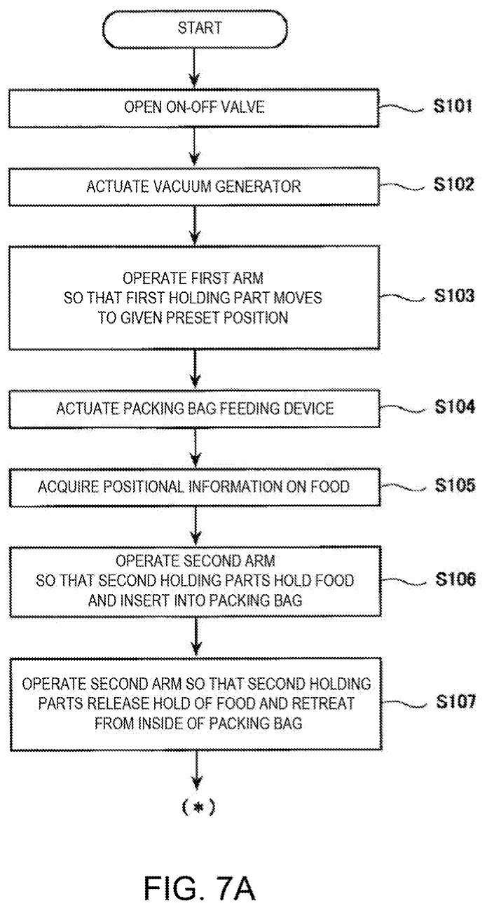

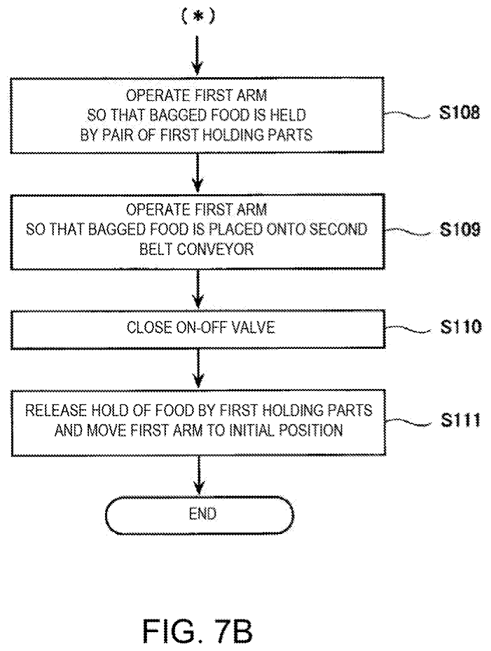

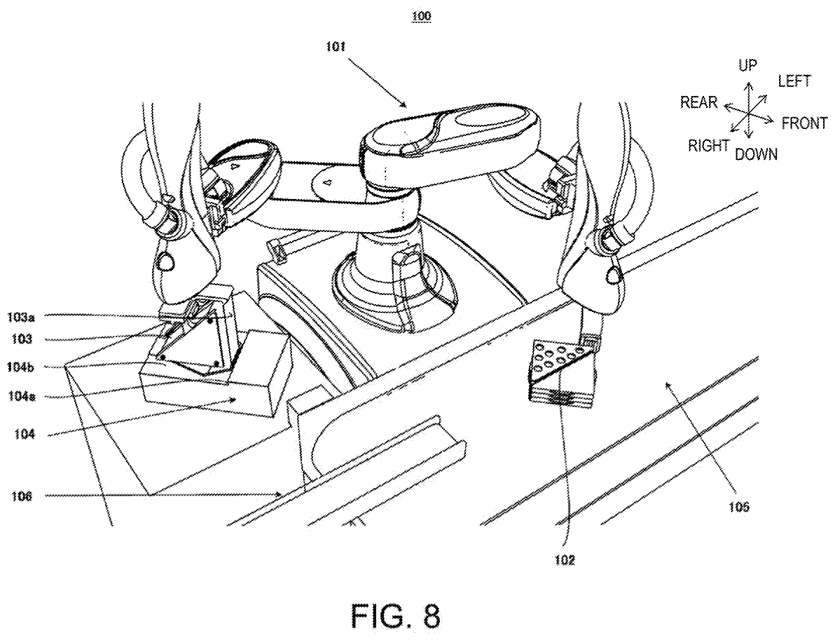

FIGS. 7A and 7B are flowcharts illustrating one example of operation of the transferring system according to Embodiment 1. FIGS. 8 to 10 are schematic views illustrating states of the robot when the robot operates according to the flowchart illustrated in FIGS. 7A and 7B.

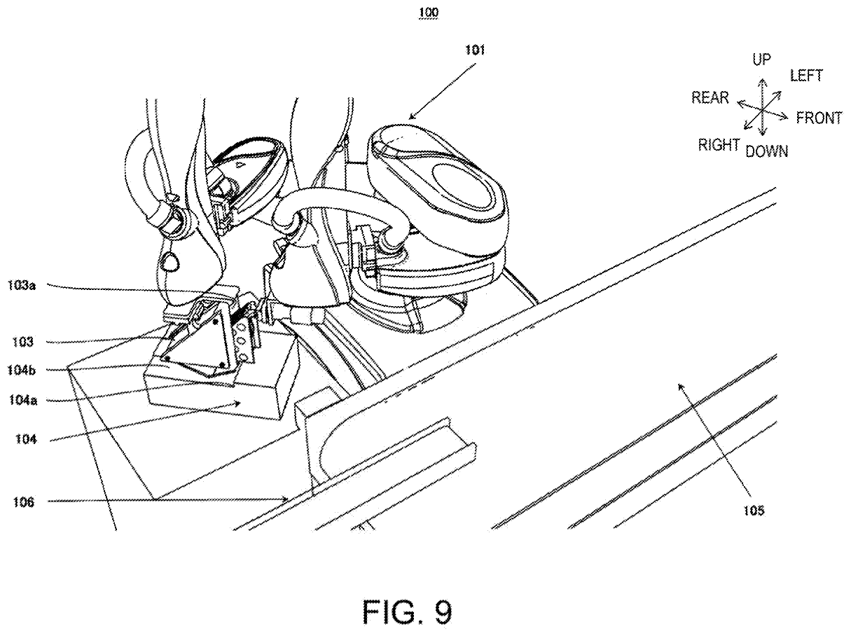

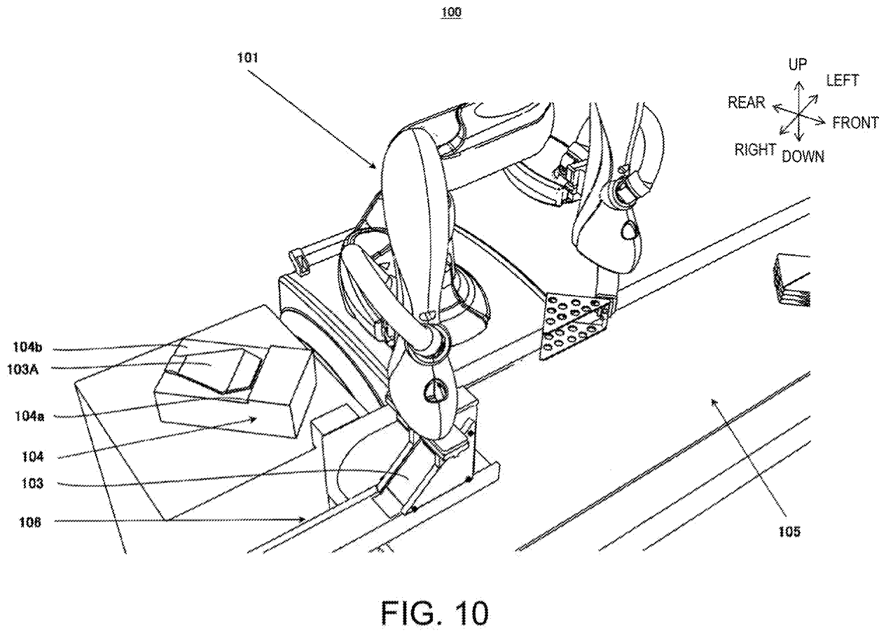

Specifically, FIG. 8 is a perspective view illustrating a state where the pair of second holding parts of the second arm hold the food (sandwiches). FIG. 9 is a perspective view illustrating a state where the food held by the pair of second holding parts is inserted into the packing bag through the opening of the packing bag. FIG. 10 is a perspective view illustrating a state where the bagged food is held by the pair of first holding parts of the first arm, and is transferred to the second belt conveyor and placed on the second belt conveyor by the first arm.

First, an operator inputs to the control device 14, through an input device (not illustrated), instruction information indicative of the operation to pack into the packing bag 103 the food 102 transferred from the first belt conveyor 105, and place the bagged food 102 onto the second belt conveyor 106.

Then, as illustrated in FIG. 1, the food 102 is transferred to a location in front of the robot 101 from the first belt conveyor 105. Then, as illustrated in FIGS. 7A and 7B, the control device 14 opens the on-off valve (not illustrated) provided at the suitable location of the first suction part 90A (Step S101), and actuates the vacuum generator 25 (Step S102).

Next, the control device 14 operates the first arm 13A so that the first holding part 80A moves to a given preset position (Step S103; refer to FIG. 1). Here, the given position is a position where the openings of the suction pads 92A can contact the side surfaces (outer surfaces) of the packing bag 103 and suck the side surfaces, when one packing bag 103 is fed by the packing bag feeding device 104, while opening the opening 103a.

At this time, the control device 14 operates the first arm 13A so that the distance between the inner surfaces of the pair of first holding parts 80A (the first plate members 81A) becomes larger than the length of the food 102. In other words, the control device 14 operates the first arm 13A so that a dimension of the opening 103a of the packing bag 103 in the width direction becomes larger than a dimension of the food 102 in the width direction. In more detail, the control device 14 operates the first arm 13A so that the dimension of the opening 103a of the packing bag 103 in the width direction becomes larger than the sum of the dimension of the food 102 in the width direction and the dimension of the pair of second holding parts 80B in the width direction.

Note that, Step S103 may be executed before or after Step S101.

Next, the control device 14 actuates the packing bag feeding device 104 (Step S104). Thus, one packing bag 103 is fed while opening the opening 103a to the upper surface 104b of the packing bag feeding device 104 by the feeder and gas feeder which are not illustrated, the side surfaces of the packing bag 103 are sucked by the suction pads 92A, and the packing bag 103 is held by the pair of first holding parts 80A.

Next, the control device 14 acquires the positional information on the food 102 (Step S105). Specifically, the control device 14 acquires the image information imaged by an imaging device (not illustrated), and acquires the positional information on the food 102 conveyed on the first belt conveyor 105 based on the acquired image information.

Next, the control device 14 operates the second arm 13B so that the pair of second holding parts 80B hold the food 102 and insert the food 102 into the packing bag 103 (Step S106; refer to FIGS. 8 and 9).

Specifically, the control device 14 operates the second arm 13B so that the second holding part 80B located below is inserted between the first belt conveyor 105 and the food 102 to place the food 102 onto the upper surface of the second holding part 80B (refer to FIG. 8).

Subsequently, the control device 14 operates at least one of the second holding parts 80B by the actuator 90B so that the lower surfaces of the second holding parts 80B located above contacts the upper surface of the food 102. Thus, the food 102 is held (pinched) by the pair of second holding parts 80B.

Subsequently, the control device 14 operates the second arm 13B so that the normal direction of the inner surfaces of the pair of second holding parts 80B is in agreement with the normal direction of the inner surfaces of the pair of first holding parts 80A to insert the food 102 into the packing bag 103 through the opening 103a of the packing bag 103 (refer to FIG. 9). That is, the control device 14 causes the actuator 90B to rotate the pedestal 81B so that the sloped surface of the food 102 is located upwardly, and inserts the food 102 into the packing bag 103 through the opening 103a of the packing bag 103.

Note that the control device 14 may execute the processings (operation) of Steps S104 and S105 before or during Steps S101-S104. That is, the control device 14 may execute the operation of the second arm 13B after the operation of the first arm 13A is finished, or may execute the operations of the first arm 13A and the second arm 13B in parallel (the first arm 13A and the second arm 13B may cooperatively perform the operations).

Next, the control device 14 operates the second arm 13B so that the hold of the food 102 by the second holding parts 80B is released, and the second holding parts 80B retreat from the inside of the packing bag 103 (Step S107).

Next, the control device 14 operates the first arm 13A so that the bagged food 102 is held by the pair of first holding parts 80A (Step S108). Specifically, the control device 14 causes the actuator (not illustrated) to move at least one of the first holding parts 80A in the normal direction of the principal surface of the first plate members 81A. Thus, the pair of first holding parts 80A pinch the food 102 through the suction pads 92A and the side surfaces of the packing bag 103.

Next, the control device 14 operates the first arm 13A so that the bagged food 102 is placed onto the second belt conveyor 106 (Step S109; refer to FIG. 10). Subsequently, the control device 14 closes the on-off valve (not illustrated) (Step S110). Thus, the suction of the side surfaces of the packing bag 103 by the suction pads 92A is canceled (stopped).

Next, the control device 14 releases the hold (pinch) of the food 102 by the pair of first holding parts 80A, moves the first arm 13A to an initial position (Step S111), and ends this program. Note that the control device 14 may output information indicating that this program is finished (for example, an image, sound, light, etc.).

### [Operation and Effects of Transferring System]

In the transferring system 100 according to Embodiment 1 configured in this way, the outer surface of the packing bag 103 is held by the pair of first holding parts 80A so that the distance between the inner surfaces of the pair of first plate members 81A becomes larger than the length of the food 102. That is, the outer surface of the packing bag 103 is held by the pair of first holding parts 80A so that the dimension of the opening 103a of the packing bag 103 in the width direction becomes larger than the dimension of the food 102 in the width direction.

Thus, the food 102 held by the pair of second holding parts 80B can be easily inserted into the packing bag 103. Moreover, when inserting the food 102 into the packing bag 103, it can be prevented that the second holding part 80B contacts the inner surface of the packing bag 103, or the second holding part 80B enters into the packing bag 103 while expanding the inner surface of the packing bag 103. Thus, breakage of the packing bag 103 can be prevented.

Moreover, when retreating the second holding part 80B from the inside of the packing bag 103, it can be prevented that the second holding part 80B contacts the inner surface of the packing bag 103, or the second holding part 80B retreating from the inside of the packing bag 103 while expanding the packing bag 103. Thus, breakage of the packing bag 103 can be prevented.

Moreover, in the transferring system 100 according to Embodiment 1, when inserting or retreating the pair of second holding parts 80B into/from the packing bag 103, the second arm 13B is operated so that the normal direction of the inner surfaces of the second holding parts 80B is in agreement with the normal direction of the inner surfaces of the first holding parts 80A (the first plate member 81A).

Thus, the second holding part 80B can advance and retreat along a portion of the packing bag 103 where the first holding parts 80A suck and hold. Moreover, since the portion of the packing bag 103 where the first holding parts 80A suck and hold is prevented from bending inwardly, it can be prevented that the second holding part 80B contacts the packing bag 103, and the breakage of the packing bag 103 can be prevented.

Moreover, even if a portion of the packing bag 103 which is not held is bent inwardly, since the second holding parts 80B advance and retreat along the portion of the packing bag 103 where the first holding parts 80A suck and hold, it can be prevented that the second holding part 80B contacts the packing bag 103, and the breakage of the packing bag 103 can be prevented.

Moreover, in the transferring system 100 according to Embodiment 1, the plurality of through-holes are formed in the principal surface of the second holding part 80B. Thus, when inserting the second holding parts 80B between the first belt conveyor 105 and the food 102, a contact surface area between the principal surface of the second holding part 80B and the food 102 can be reduced, and frictional resistance can be reduced. Thus, the food 102 can be smoothly placed onto the principal surface of the second holding part 80B.

### Embodiment 2

In the transferring system according to Embodiment 1, a control device of a transferring system according to Embodiment 2 is configured to operate the first arm and the second arm so that the food is transferred to the given preset position, while maintaining a state where the outer surface of the packing bag is sucked by the suction parts of the pair of first holding parts and maintaining a state where the food is held by the pair of second holding parts.

Moreover, in the transferring system according to Embodiment 2, the control device may be configured to operate the second arm so that the hold of the food by the pair of second holding parts is released and the pair of second holding parts are retreated from the inside of the packing bag, and operate the first arm so that the suction by the suction part of the first holding parts is stopped and the inner surfaces of the pair of first holding parts are separated from the outer surface of the packing bag.

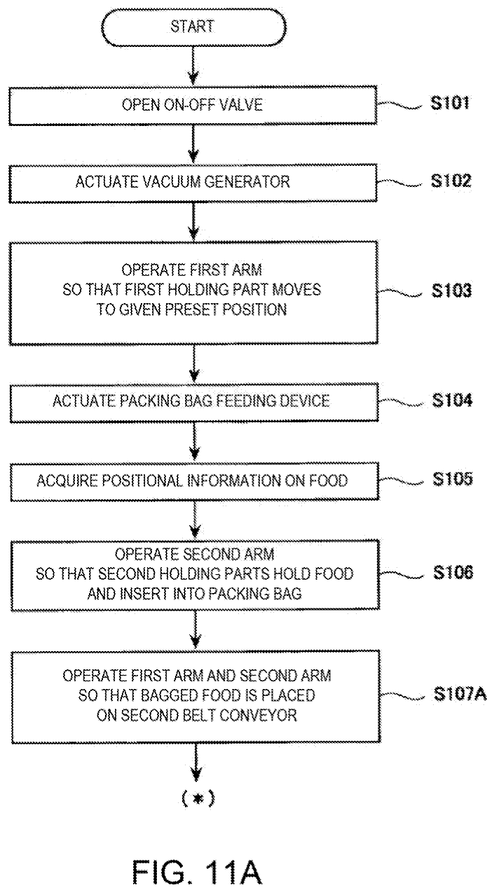

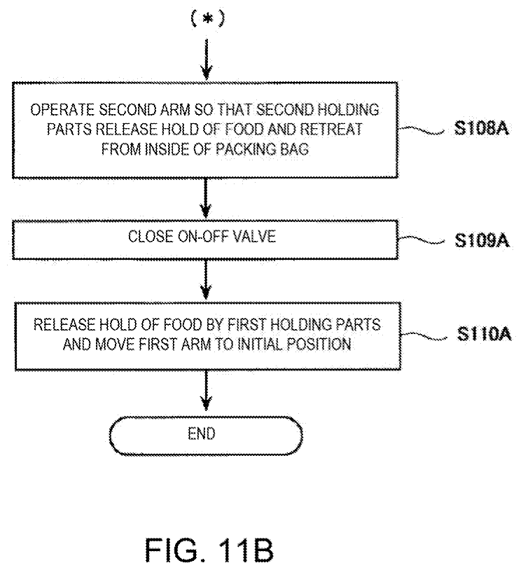

Below, one example of the transferring system according to Embodiment 2 is described with reference to FIGS. 11A and 11B. Note that, since the transferring system according to Embodiment 2 is configured similarly to the transferring system 100 according to Embodiment 1, the detailed description of the configuration is omitted.

### [Operation and Effects of Transferring System]

FIGS. 11A and 11B are flowcharts illustrating one example of operation of the transferring system according to Embodiment 2. Note that the following operation is executed by the processor 14a of the control device 14 reading the program stored in the memory 14b.

As illustrated in FIGS. 11A and 11B, although the operation of the transferring system 100 according to Embodiment 2 is performed fundamentally similar to the operation of the transferring system 100 according to Embodiment 1, it differs in that Steps S107A-S110A are executed instead of Steps S107-S111. Below, the operation of Steps S107A-S110A is described.

The control device 14 operates the first arm 13A and the second arm 13B so that, after the food 102 is bagged into the packing bag 103 at Step S106, the bagged food 102 is placed on the second belt conveyor 106 (the given preset position) (Step S107A).

Specifically, the control device 14 rotates the first arm 13A and the second arm 13B counterclockwise so that the food is placed on the second belt conveyor 106, while maintaining the state where the outer surface of the packing bag 103 is sucked by the first suction parts 90A of the pair of first holding parts 80A, and maintaining the state where the food 102 is held by the pair of second holding parts 80B.

Next, the control device 14 operates the second arm 13B so that the hold of the food 102 by the pair of second holding parts 80B is released, and the second holding parts 80B are retreated from the inside of the packing bag 103 (Step S108A). Subsequently, the control device 14 closes the on-off valve (not illustrated) (Step S109A). Thus, the suction of the side surfaces of the packing bag 103 by the suction pad 92A is canceled (stopped).

Next, the control device 14 releases the hold (pinch) of the food 102 by the pair of first holding parts 80A, moves the first arm 13A to the initial position (Step S110A), and ends this program. Note that the control device 14 may output information indicating that this program is finished (for example, an image, sound, light, etc.).

The transferring system 100 according to Embodiment 2 configured in this way also has similar operation and effects to the transferring system 100 according to Embodiment 1.

### Embodiment 3

In the transferring system according to Embodiment 1 or 2, a transferring system according to Embodiment 3 is provided with a pair of robots which are disposed opposing to each other on both sides of the food.

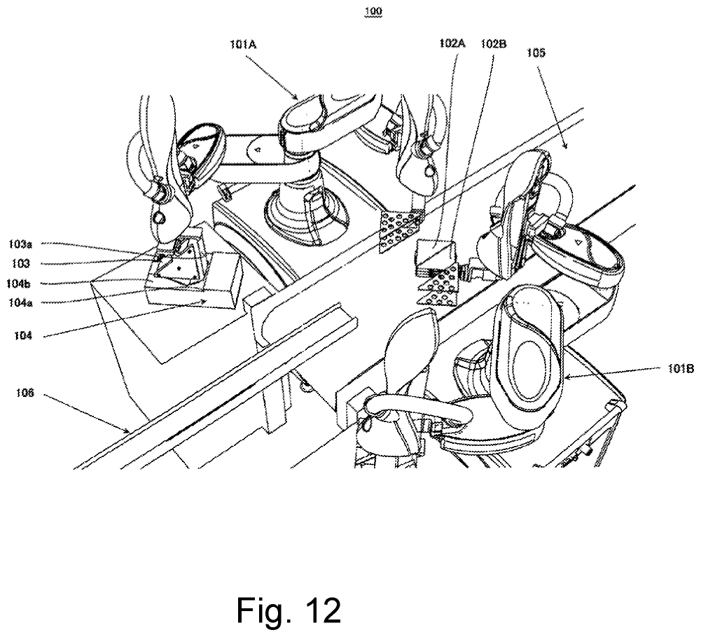

Below, one example of the transferring system according to Embodiment 3 is described with reference to FIG. 12.

FIG. 12 is a schematic view illustrating an outline structure of the transferring system according to Embodiment 3.

As illustrated in FIG. 12, the transferring system 100 according to Embodiment 3 includes a pair of robots 101A and 101B disposed so as to oppose to each other on both sides of foods 102A and 102B, and is configured so that the robot 101A transfers the food 102A and the robot 101B transfers the food 102B.

Note that, since the robot 101A and the robot 101B are configured similarly to the robot 101 of the transferring system 100 according to Embodiment 1, the detailed description is omitted.

Moreover, as illustrated in FIG. 12, the food 102A and the food 102B are disposed on the first belt conveyor 105 so that their sloped surfaces contact each other. In Embodiment 3, the robot 101A and the robot 101B are configured to operate simultaneously to transfer the food 102A and the food 102B.

Here, the term “simultaneously” as used herein does not refer to a concept only encompassing a perfect match, but refers to a concept that permits some time lags. Specifically, for example, when inserting the second holding part 80B of the robot 101A located below into a space between the first belt conveyor 105 and the food 102, and placing the food 102A onto the upper surface of the second holding part 80B, the robot 101A and the robot 101B may be operated so that at least a part of the food 102B is placed onto the upper surface of the second holding part 80B of the robot 101B. In other words, the robot 101A and the robot 101B may be operated so that, while the food 102A is placed on the upper surface of the second holding part 80B of the robot 101A, at least a part of the food 102B is placed onto the upper surface of the second holding part 80B of the robot 101B.

Moreover, for example, although depending on the operating speed of the robot 101A and the robot 101B, there may be a difference for about ±1 to ±2 seconds.

Note that, the transferring operation of the food 102A or the food 102B by the robot 101A or the robot 101B may be performed similarly to the transferring system 100 according to Embodiment 1, or may be performed similarly to the transferring system 100 according to Embodiment 2.

The transferring system 100 according to Embodiment 3 configured in this way also has similar operation and effects to the transferring system 100 according to Embodiment 1.

Moreover, in the transferring system 100 according to Embodiment 3, when the robot 101A places the food 102A onto the upper surface of the second holding part 80B, the second arm 13B is operated so that the robot 101B inserts the second holding part 80B located below into a space between the first belt conveyor 105 and the food 102B.

Thus, the second arm 13B of the robot 101A and the second arm 13B of the robot 101B operate so as to approach each other. Thus, even if the food 102A and/or the food 102B try to move in the front-and-rear direction of the robot 101A, the foods 102A and 102B push each other to prevent the movement of the foods 102A and 102B in the front-and-rear direction.

Therefore, in the transferring system 100 according to Embodiment 3, the food 102A or the food 102B can be more smoothly placed on the upper surfaces of the second holding parts 80B, as compared with the transferring system 100 according to Embodiment 1 or 2.

It is apparent for a person skilled in the art that many improvements or other embodiments of the present disclosure are possible from the above description. Therefore, the above description is to be interpreted only as illustration, and it is provided in order to teach a person skilled in the art the best mode that implements the present disclosure. The detail of the structures and/or the functions may be changed substantially, without departing from the spirit of the present disclosure.

### INDUSTRIAL APPLICABILITY

Since the transferring system of the present disclosure and the method of operating the same can transfer the gripped food into the packing bag, while preventing the breakage of the packing bag, they are useful in the field of industrial robots.

### DESCRIPTION OF REFERENCE CHARACTERS

5a First Link
5b Second Link
12 Carrier
13A First Arm
13B Second Arm
14 Control Device
14a Processor
14b Memory
14c Servo Controller
15A First Arm Part
15B Second Arm Part
16 Base Shaft
17A First Wrist Part
17B Second Wrist Part
18A First Hand Part
18B Second Hand Part
20A First Attaching Part
20B Second Attaching Part
25 Vacuum Generator
60A Stationary Part
60B Stationary Part
70A Main Body
70B Main Body
71A First Member
72A Second Member
80A First Holding Part
80B Second Holding Part
81A First Plate Member
81B Pedestal
82A Second Member
90A First Suction Part
90B Actuator
91A Opening
92A Suction Pad
93A First Piping
100 Transferring System
101 Robot
101A Robot
101B Robot
102 Food
102A Food
102B Food
103 Packing Bag
103a Opening
104 Packing Bag Feeding Device
104a Stepped Part
104b Upper Surface
104c Stepped Part
105 First Belt Conveyor
106 Second Belt Conveyor
J1 Rotary Joint
J2 Rotary Joint
J3 Linear-motion Joint
J4 Rotary Joint
L1 Rotation Axis
L2 Rotation Axis
L3 Rotation Axis
L4 Rotation Axis

1. A transferring system configured to hold and transfer food, comprising:
a robot including:
a first arm having a pair of first holding parts, each formed in a plate shape, the first holding parts being disposed so that inner surfaces thereof oppose to each other, and configured to be changeable of a distance between the inner surfaces; and
a second arm having a pair of second holding parts, each formed in a plate shape, and the second holding parts being disposed so that inner surfaces thereof oppose to each other,
a packing bag feeding device configured to feed each of stacked packing bags one by one, while opening an opening of the packing bag; and
a control device,
wherein a suction part is provided to the inner surface of the first holding part,
wherein the control device operates the packing bag feeding device to feed the packing bag while opening the opening of the packing bag, then operates the first arm so that the inner surfaces of the pair of first holding parts contact the outer surface of the packing bag, the suction part sucks the outer surface of the packing bag, and a distance between the inner surfaces of the pair of first holding parts becomes larger than a length of the food.

2. The transferring system of claim 1, wherein the control device operates the second arm so that the food is held by the pair of second holding parts, and the held food is inserted into the packing bag through the opening of the packing bag.

3. The transferring system of claim 2, wherein the control device operates the second arm so that a normal direction of the inner surfaces of the pair of second holding parts is in agreement with a normal direction of the inner surfaces of the pair of first holding parts.

4. The transferring system of claim 2, wherein the control device operates the second arm so that the pair of second holding parts release the hold of the food, and retreat from the inside of the packing bag, and then operates the first arm so that the pair of first holding parts hold the food from the outer surface of the packing bag.

5. The transferring system of claim 2, wherein the control device operates the first arm and the second arm so that the food is transferred to a given preset position, while maintaining a state where the suction parts of the pair of first holding parts suck the outer surface of the packing bag, and maintaining a state where the pair of second holding parts hold the food.

6. The transferring system of claim 5, wherein the control device operates the second arm so that the pair of second holding parts release the hold of the food, and the pair of second holding parts retreat from the inside of the packing bag, and operates the first arm so that the suction parts of the first holding parts stop the suction, and the inner surfaces of the pair of first holding parts separate from the outer surface of the packing bag.

7. The transferring system of claim 1, wherein the robot includes a pair of robots disposed so as to oppose to each other on both sides of the food.

8. A method of operating a transferring system configured to hold and transfer food, the transferring system comprising:
a robot including:
a first arm having a pair of first holding parts, each formed in a plate shape, and the first holding parts being disposed so that inner surfaces thereof oppose to each other, and configured to be changeable of a distance between the inner surfaces; and
a second arm having a pair of second holding parts, each formed in a plate shape, and the second holding parts being disposed so that inner surfaces thereof oppose to each other, and
a packing bag feeding device configured to feed each of stacked packing bags one by one, while opening an opening of the packing bag,
wherein a suction part is provided to the inner surface of the first holding part,
the method comprising the steps of:
(A) operating the packing bag feeding device to feed the packing bag while opening the opening of the packing bag; and
(B) operating the first arm so that the inner surfaces of the pair of first holding parts contact the outer surface of the packing bag, the suction part sucks the outer surface of the packing bag, and a distance between the inner surfaces of the pair of first holding parts becomes larger than a length of the food, after (A).

9. The method of claim 8, further comprising (C) operating the second arm so that the food is held by the pair of second holding parts, and the held food is inserted into the packing bag through the opening of the packing bag.

10. The method of claim 9, wherein (C) includes operating the first arm so that a normal direction of the inner surfaces of the pair of second holding parts is in agreement with a normal direction of the inner surfaces of the pair of first holding parts.

11. The method of claim 8, further comprising:
(D) operating the second arm so that the pair of second holding parts release the hold of the food, and retreat from the inside of the packing bag; and
(E) operating the first arm so that the pair of first holding parts hold the food from the outer surface of the packing bag, after (D).

12. The method of claim 9, further comprising (F) operating the first arm and the second arm so that the food is transferred to a given preset position, while maintaining a state where the pair of second holding parts hold the food, and maintaining a state where the suction parts of the pair of first holding parts suck the outer surface of the packing bag.

13. The method of claim 12, further comprising:
(G) operating the second arm so that the pair of second holding parts release the hold of the food, and the pair of second holding parts retreat from the inside of the packing bag; and
(H) operating the first arm so that the suction parts of the first holding parts stop the suction, and the inner surfaces of the pair of first holding parts separate from the outer surface of the packing bag.
